(19) United States
(12) Patent Application Publication
(10) Pub. No.: US 2016/0064711 A1
(43) Pub. Date: Mar. 3, 2016

(54) PREPARATION METHOD OF POROUS COMPOSITE SEPARATOR

(71) Applicants: Ningde Amperex Technology Limited, Ningde (CN); Dongguan Amperex Technology Limited, Dongguan (CN)

(72) Inventors: Junhua ZHAO, Dongguan (CN); Shenglong WANG, Dongguan (CN); Shengwu ZHANG, Dongguan (CN); Baiqing ZHANG, Dongguan (CN)

(21) Appl. No.: 14/832,608

(22) Filed: Aug. 21, 2015

(30) Foreign Application Priority Data
Aug. 26, 2014 (CN) 201410425628.6

(51) Int. Cl. H01M 2/14; B29C 37/00; B29C 47/88; H01M 2/16; H01M 10/0525

(52) U.S. Cl. CPC H01M 2/145; H01M 2/1686; H01M 10/0525; B29C 47/8805; B29C 37/0025; B29K 2101/00

(57) ABSTRACT

The present disclosure provides a preparation method of a porous composite separator, which comprises steps of: (1) a forming process of a porous separator substrate: taking organic particles as a raw material to obtain a porous separator substrate; (2) a coating process of a functional material layer: coating a functional material layer on at least one surface of the obtained porous separator substrate to obtain a porous separator substrate having a functional material layer; (3) a heat treating process: drying the functional material layer and heating the porous separator substrate and the functional material layer on the surface of the obtained porous separator substrate to obtain a porous composite separator. The preparation method can prepare a porous composite separator with an excellent performance in high efficiency and low cost, the porous composite separator has high porosity, high air permeability, high binding performance, high mechanical strength and high thermal stability.

### CROSS-REFERENCE TO RELATED APPLICATIONS

The present application claims priority to Chinese patent application No. CN201410425628.6, filed on Aug. 26, 2014, which is incorporated herein by reference in its entirety.

### FIELD OF THE PRESENT DISCLOSURE

The present disclosure relates to a field of a lithium-ion secondary battery, and more specifically relates to a preparation method of a porous composite separator.

### BACKGROUND OF THE PRESENT DISCLOSURE

In order to resolve safety problems (such as internal short circuit, deformation and the like) that easily exist in electrochemical devices (such as a lithium-ion secondary battery) which conventionally use polyolefin and non-woven and the like to act as a separator, many patent documents disclose a method of coating a functional material layer (such as poly(vinylidene fluoride) (PVDF) layer, aluminum oxide layer and the like) on a separator substrate to improve the thermal stability and the mechanical strength of a separator, and improve the adhesive performance in the electrochemical device. Typically a functional material layer is coated on a prepared or even a narrow-width porous separator substrate (such as polyolefin, non-woven and the like) and then dried. The above preparation method further increases the production cost of the separator which originally remains high, and it is quite not beneficial for the production cost control of the electrochemical device.

Chinese patent document published as No. CN103199208A on Jul. 10, 2013 discloses a production method of a separator for a lithium-ion battery, in this production method, calcium carbonate is used as a pore forming material, hydrosolvent is used as an extractant to substitute the conventional organic solvent, so as to obtain a separator with a low production cost. However, in order to improve the safety performance and the mechanical strength and the like of the separator, a porous composite separator having a porous separator substrate which is prepared from polyolefin and non-woven and the like and a functional material layer is still needed. Therefore how to prepare a porous composite separator in high efficiency and low cost has become an emergent problem.

### SUMMARY OF THE PRESENT DISCLOSURE

In view of the problems existing in the background technology, an object of the present disclosure is to provide a preparation method of a porous composite separator, which can prepare a porous composite separator with an excellent performance in high efficiency and low cost, the porous composite separator has high porosity and high air permeability, and also has high binding performance, high mechanical strength and high thermal stability.

In order to achieve the above object, the present disclosure provides a preparation method of a porous composite separator which comprises steps of: (1) a forming process of a porous separator substrate: taking organic particles as a raw material to obtain a porous separator substrate; (2) a coating process of a functional material layer: coating a functional material layer on at least one surface of the obtained porous separator substrate to obtain a porous separator substrate having a functional material layer; (3) a heat treating process: drying the functional material layer and heating the porous separator substrate and the functional material layer on the surface of the porous separator substrate to obtain a porous composite separator.

The present disclosure has following beneficial effects:

1. In the preparation method of the porous composite separator of the present disclosure, the coating process of the functional material layer is integrated into the conventional preparation method of the porous separator substrate, therefore the coating system and the drying system which are conventionally required in the coating process of the functional material layer are omitted, thereby improving the production efficiency and lowering the production cost.

2. The thickness and the mechanical strength of the porous composite separator are directly increased after the functional material layer is coated, thereby decreasing nonuniformity of tension on the porous separator substrate, and improving the qualified yield of the porous separator substrate, and decreasing the heat shrinkage of the porous separator substrate, and in turn improving the stability of the porous separator substrate in the heat treating process, and decreasing the strict requirements on the tension system in the heat treating process.

3. The porous separator substrate before the heat treating process mainly is in amorphous phase, the polymer on the surface of the porous separator substrate is in open chain state, therefore performing a coating process on the functional material layer and then performing a heat treating process on the functional material layer at this time can significantly improve the interaction between the porous separator substrate and the functional material layer, and a porous composite separator with high adhesive performance, high mechanical strength and high thermal stability can be obtained by adding a heat treating process to the existing processing technology for forming the functional material layer.

### DETAILED DESCRIPTION

Hereinafter a preparation method of a porous composite separator and comparative examples, examples and test results according to the present disclosure will be described in detail.

Firstly, a preparation method of a porous composite separator of the present disclosure will be described. A preparation method of a porous composite separator of the present disclosure comprises steps of: (1) a forming process of a porous separator substrate: taking organic particles as a raw material to obtain a porous separator substrate; (2) a coating process of a functional material layer: coating a functional material layer on at least one surface of the obtained porous separator substrate to obtain a porous separator substrate having a functional material layer; (3) a heat treating process: drying the functional material layer and heating the porous separator substrate and the functional material layer on the surface of the porous separator substrate to obtain a porous composite separator.

In the preparation method of the porous composite separator of the present disclosure, the coating process of the functional material layer is integrated into the conventional preparation method of the porous separator substrate, therefore the coating system and the drying system which are conventionally required in the coating process of the functional material layer are omitted, thereby improving the production efficiency and lowering the production cost. The thickness and the mechanical strength of the porous composite separator are directly increased after the functional material layer is coated, thereby decreasing nonuniformity of tension on the porous separator substrate, and improving the qualified yield of the porous separator substrate, and decreasing the heat shrinkage of the porous separator substrate, and in turn improving the stability of the porous separator substrate in the heat treating process, and decreasing the strict requirements on the tension system in the heat treating process. The porous separator substrate before the heat treating process mainly is in amorphous phase, the polymer on the surface of the porous separator substrate is in open chain state, therefore performing a coating process on the functional material layer and then performing a heat treating process on the functional material layer at this time can significantly improve the interaction between the porous separator substrate and the functional material layer, and a porous composite separator with high adhesive performance, high mechanical strength and high thermal stability can be obtained by adding a heat treating process to the existing processing technology for forming the functional material layer.

In the preparation method of the porous composite separator of the present disclosure, in the step (1), the porous separator substrate may be a wide-width porous separator substrate (a width thereof is more than 2 m), so that the functional material layer may be directly coated on the wide-width porous separator substrate, thereby reducing the amount of leftover bits and pieces produced in the cutting process where the wide-width porous separator substrate is cut into a plurality of narrow-width porous separator substrates, and further improving the production efficiency and lowering the production cost. In the production process of the wide-width porous separator substrate, the porous separator substrates at different locations may be nonuniform in mass (which is typically caused by the nonuniform thickness of the wide-width porous separator substrate), a conventional method is to cut the wide-width porous separator substrate into a plurality of narrow-width porous separator substrates first and then classify the plurality of narrow-width porous separator substrates according to the mass of each narrow-width porous separator substrate, however, in the present disclosure, the functional material layer is directly coated on the surface of the wide-width porous separator substrate, which not only decreases the unqualified rate caused by the nonuniform thickness of the porous separator substrate, but also improves the wavy edge problem of the porous separator substrate in appearance, and even makes that the unqualified products due to appearance change into qualified products possible.

In the preparation method of the porous composite separator of the present disclosure, in the step (1), a first kind of forming process of the porous separator substrate comprises substeps of: mixing organic particles, plasticizer and solvent to obtain a mixed material; extruding the obtained mixed material and performing a processing (such as mechanical stretching or nonwovening) to form a base membrane; immersing the formed base membrane into extractant to form a porous separator substrate. The organic particle may be at least one selected from a group consisting of vinyl polymer and copolymers thereof, fluoropolymer, polyimide, nitrile containing polymer, polyamide, polyester and siloxane polymer. More specifically, the organic particle may be at least one selected from a group consisting of polyethylene, polypropylene, ethylene vinyl acetate copolymer, polyvinylidene fluoride, vinylidene fluoride-hexafluoropropylene copolymer, polyimide, polyacrylonitrile, acrylonitrile-butadiene copolymer, acrylonitrile-styrene-butadiene copolymer, poly(p-phenylene terephthamide), polyisophthaloyl metaphenylene diamine, polymethyl methacrylate, polymethyl acrylate, polyethyl acrylate, acrylic acid-styrene copolymer and polydimethyl siloxane. The plasticizer may be at least one selected from a group consisting of paraffin oil, dioctyl phthalate and diethyl phthalate. The solvent may be at least one selected from a group consisting of N-methyl-2-pyrrolidone, N, N-dimethyl acetamide, N, N-dimethyl formamide, dmethyl sulfoxide, acetonitrile, acetone, denioned water, hydric alcohol and polyhydric alcohol. The extractant may be at least one selected from a group consisting of methylene dichloride, dichloroethane, trichloroethane, dichloroethylene, trichloroethylene, n-hexane, n-heptane, acetone, ethyl alcohol, butyl alcohol and ethylene glycol. The extrusion of the mixed material may be single screw extrusion or double screw extrusion. Moreover, a filler may be added into the mixed material, the filler may be at least one selected from a group consisting of lithium carbonate, calcium carbonate, magnesium carbonate, aluminium carbonate, strontium carbonate, lithium titanium carbonate, lithium aluminium titanium carbonate, lithium lanthanum carbonate, lithium sulfate, calcium sulfate, magnesium sulfate, aluminium sulfate, strontium sulfate, lithium titanium sulfate, lithium aluminium titanium sulfate, lithium lanthanum sulfate, silicon dioxide, aluminum oxide, titanium dioxide, lithium phosphate and lithium titanium phosphate.

In the preparation method of the porous composite separator of the present disclosure, in the step (1), a second kind of forming process of the porous separator substrate comprises substeps of: extruding a melt of organic particles; performing a processing (such as mechanical stretching or nonwovening) on the extruded melt to form a porous separator substrate. The organic particle may be at least one selected from a group consisting of vinyl polymer and copolymers thereof, fluoropolymer, polyimide, nitrile containing polymer, polyamide, polyester and siloxane polymer. More specifically, the organic particle may be at least one selected from a group consisting of polyethylene, polypropylene, ethylene vinyl acetate copolymer, polyvinylidene fluoride, vinylidene fluoride-hexafluoropropylene copolymer, polyimide, polyacrylonitrile, acrylonitrile-butadiene copolymer, acrylonitrile-styrene-butadiene copolymer, poly(p-phenylene terephthamide), polyisophthaloyl metaphenylene diamine, polymethyl methacrylate, polymethyl acrylate, polyethyl acrylate, acrylic acid-styrene copolymer and polydimethyl siloxane. The extrusion of the melt may be single screw extrusion or double screw extrusion.

In the preparation method of the porous composite separator of the present disclosure, when the organic particle is vinyl polymer and copolymers thereof (that is the porous separator substrate is a polyolefin separator), the forming process of the porous separator substrate may be one selected from a group consisting of dry-way uniaxial stretch, dry-way biaxial stretch, wet-way uniaxial stretch and wet-way biaxial stretch. The uniaxial stretch may be transverse uniaxial stretch or longitudinal uniaxial stretch, the biaxial stretch may be transverse and longitudinal stretch at the same time, first transverse and then longitudinal stretch or first longitudinal and then transverse stretch.

In the preparation method of the porous composite separator of the present disclosure, when the organic particle is vinyl polymer and copolymers thereof (that is the porous separator substrate ia a polyolefin separator), in the heat treating process, crystallization is conducted on the porous separator substrate and a drying process is conducted on the functional material layer at the same time.

In the preparation method of the porous composite separator of the present disclosure, when the organic particle is vinyl polymer and copolymers thereof (that is the porous separator substrate ia a polyolefin separator), the heat treating process on the porous separator substrate mainly refers to a heat setting treatment.

In the preparation method of the porous composite separator of the present disclosure, when the organic particle is at least one selected from a group consisting of fluoropolymer, polyimide, nitrile containing polymer, polyamide, polyester and siloxane polymer (that is the porous separator substrate is a non-woven type separator), the forming method of the porous separator substrate may be one selected from a group consisting of heat seal non-woven method, wet process non-woven method, spunbond non-woven method, meltblown non-woven method, electrospinning method and airlaid pulp non-woven method.

In the preparation method of the porous composite separator of the present disclosure, in the step (1), a thickness of the obtained porous separator substrate may be 3 μm˜45 μm.

In the preparation method of the porous composite separator of the present disclosure, a porosity of the porous composite separator may be 39˜48%.

In the preparation method of the porous composite separator of the present disclosure, in the step (2), the functional material layer is one selected from a group consisting of inorganic coating, organic/inorganic composite coating and organic coating. The organic component in the organic coating and the organic/inorganic composite coating may be one or more selected from a group consisting of polymers having a lithium ion conductivity, heat resistant polymers and flame resistant polymers. Specifically, the organic component may be one or more selected from a group consisting of polyvinylidene fluoride, vinylidene fluoride-hexafluoropropylene copolymer, acrylonitrile-styrene-butadiene copolymer, polyacrylonitrile, polyethyl acrylate, acrylic acid-styrene copolymer, acrylonitrile-butadiene copolymer, polyisophthaloyl metaphenylene diamine, polyimide, poly(p-phenylene terephthamide) and polymethyl acrylate. The inorganic component in the inorganic coating and the organic/inorganic composite coating may be one or more selected from a group consisting of aluminum oxide, silicon dioxide, titanium dioxide, cerium dioxide, calcium carbonate, calcium oxide, zinic oxide, magnesium oxide, cerium titanate, calcium titanate, barium titanate, lithium phosphate, lithium titanium phosphate, lithium aluminum titanium phosphate, lithium nitride and lithium lanthanum titanate. A particle diameter of the inorganic component in the inorganic coating and the organic/inorganic composite coating may be 0.001 μm˜9 μm.

In the preparation method of the porous composite separator of the present disclosure, in the step (2), a thickness of a single layer of the functional material layer is 1 μm˜25 μm.

In the preparation method of the porous composite separator of the present disclosure, in the step (2), a coating method of the functional material layer may be one selected from a group consisting of dip coating, gravure printing, micro-gravure coating, screen printing, transfer coating, extrusion coating, spray coating and cast coating.

In the preparation method of the porous composite separator of the present disclosure, in the step (3), the heat treating process comprises a substep of a high temperature treating process and a substep of a low temperature treating process which are sequentially performed, an operating temperature of the high temperature treating process is higher than an operating temperature of the low temperature treating process, and the operating temperature of the high temperature treating process is 100° C.˜300° C., the operating temperature of the low temperature treating process is 40° C.˜100° C. A main function of the high temperature treating process is to perform a heat treatment on the porous separator substrate and dry the functional material layer, a main function of the low temperature treating process is to perform a further heat treatment on the porous separator substrate and the functional material layer on the surface of the porous separator substrate.

In the preparation method of the porous composite separator of the present disclosure, in the step (3), a multi-stage oven is used in the heat treating process, a preset temperature of the multi-stage oven is 40° C.˜300° C., a running speed of the porous separator substrate having the functional material layer is 5 m/min˜90 m/min. The multi-stage oven may be a two-stage oven, a three-stage oven or a four-stage oven. However, without limitation, the multi-stage oven may also be a multi-stage oven where there are more than four stages. In the multi-stage oven, which stage is used in the high temperature treating process and which stage is used in the low temperature treating process may be determined based on the number of the stages of the multi-stage oven and the sequence of the stages. For example, for the three-stage oven, the first two stages may be used for the high temperature treating process and the third stage may be used for the low temperature treating process. For example, for the four-stage oven, the first two stages may be used for the high temperature treating process and the last two stages may be used for the low temperature treating process.

Then comparative examples and examples of the preparation method of the porous composite separator according to the present disclosure would be described.

### Comparative Example 1

### (1) A Forming Process of a Porous Separator Substrate

Organic particles (polyethylene), plasticizer (paraffin oil) and solvent (acetone) according to a weight ratio of 55:15:30 were uniformly mixed and extruded via a double screw extruder, which was first transversely and then longitudinaly stretched to form a base membrane, a transverse elongation of the stretching process was 900%, a longitudinal elongation of the stretching process was 700%, a thickness of the formed base membrane was 11 μm, a width of the formed base membrane was 2.2 m; then the formed base membrane was immersed into extractant (dichloroethane) to form a porous separator substrate.

### (2) A Heat Treating Process

The formed porous separator substrate was heat setted via a three-stage oven (the temperatures of the three stages were 160° C., 160° C. and 75° C., respectively) at a running speed of 38 m/min.

### (3) A Coating Process of a Functional Material Layer

Slurry containing aluminum oxide (a particle diameter was 0.6 μm) was coated on both surfaces of the porous separator substrate via dip coating to obtain a wet membrane.

### (4) A Drying Process

The wet membrane was dried via a three-stage oven (the temperatures of the three stages were 50° C., 45° C. and 42° C., respectively) at a running speed of 25 m/min, finally a porous composite separator was obtained, and a thickness of a single layer of the functional material layer was 5 μm (that was the thickness of the functional material layer was 10 μm).

### Comparative Example 2

### (1) A Forming Process of a Porous Separator Substrate

Organic particles (polyethylene) were melt and extruded via a double screw extruder, which was first transversely and then longitudinaly stretched to form a porous separator substrate, a transverse elongation of the stretching process was 900%, a longitudinal elongation of the stretching process was 700%, a thickness of the formed porous separator substrate was 12 μm, a width of the formed porous separator substrate was 2.2 m.

### (2) A Heat Treating Process

The formed porous separator substrate was heat setted via a three-stage oven (the temperatures of the three stages were 150° C., 150° C. and 60° C., respectively) at a running speed of 35 m/min.

### (3) A Coating Process of a Functional Material Layer

Slurry containing vinylidene fluoride-hexafluoropropylene copolymer was coated on both surfaces of the porous separator substrate via dip coating to obtain a wet membrane.

### (4) A Drying Process

The wet membrane was dried via a three-stage oven (the temperatures of the three stages were 50° C., 45° C. and 42° C., respectively) at a running speed of 25 m/min, finally a porous composite separator was obtained, and a thickness of a single layer of the functional material layer was 5 μm (that was the thickness of the functional material layer was 10 μm).

### Example 1

### (1) A Forming Process of a Porous Separator Substrate

Organic particles (polyethylene), plasticizer (paraffin oil) and solvent (acetone) according to a weight ratio of 50:10:40 were uniformly mixed and extruded via a double screw extruder, which was first transversely and then longitudinaly stretched to form a base membrane, a transverse elongation of the stretching process was 900%, a longitudinal elongation of the stretching process was 700%, a thickness of the formed base membrane was 11 μm, a width of the formed base membrane was 2.2 m; then the formed base membrane was immersed into extractant (dichloroethane) to form a porous separator substrate.

### (2) A Coating Process of a Functional Material Layer

Slurry containing aluminum oxide (a particle diameter thereof was 0.6 μm) was coated on both surfaces of the formed porous separator substrate via dip coating to obtain a wet membrane.

### (3) A Drying Process

The wet membrane was dried via a three-stage oven (the temperatures of the three stages were 160° C., 160° C. and 75° C., respectively) at a running speed of 38 m/min, finally a porous composite separator was obtained, and a thickness of a single layer of the functional material layer was 5 μm (that was the thickness of the functional material layer was 10 μm).

### Example 2

### (1) A Forming Process of a Porous Separator Substrate

Organic particles (polypropylene), plasticizer (dioctyl phthalate), solvent (N-methyl-2-pyrrolidone) and filler (calcium carbonate) according to a weight ratio of 45:8:30:17 were uniformly mixed and extruded via a single screw extruder, which was first longitudinaly and then transversely stretched to form a base membrane, a transverse elongation of the stretching process was 50%, a longitudinal elongation of the stretching process was 50%, a thickness of the formed base membrane was 45 μm, a width of the formed base membrane was 2.1 m; then the formed base membrane was immersed into extractant (n-hexane) to form a porous separator substrate.

### (2) A Coating Process of a Functional Material Layer

Slurry containing silicon dioxide (a particle diameter thereof was 0.01 μm) was coated on one surface of the formed porous separator substrate via spray coating to obtain a wet membrane.

### (3) A Drying Process

The wet membrane was dried via a three-stage oven (the temperatures of the three stages were 300° C., 200° C. and 90° C., respectively) at a running speed of 5 m/min, finally a porous composite separator was obtained, and a thickness of the functional material layer was 1 μm.

### Example 3

### (1) A Forming Process of a Porous Separator Substrate

Organic particles (polyvinylidene fluoride), plasticizer (diethyl phthalate), solvent (N,N-dimethyl formamide) and filler (lithium sulfate) according to a weight ratio of 35:4:45:16 were uniformly mixed and extruded via a double screw extruder, which was transversely and longitudinaly stretched at the same time to form a base membrane, a transverse elongation of the stretching process was 1000%, a longitudinal elongation of the stretching process was 800%, a thickness of the formed base membrane was 15 μm, a width of the formed base membrane was 2.3 m; then the formed base membrane was immersed into extractant (trichloroethylene) to form a porous separator substrate.

### (2) A Coating Process of a Functional Material Layer

Slurry containing magnesium oxide (a particle diameter thereof was 9 μm) was coated on one surface of the formed porous separator substrate via cast coating to obtain a wet membrane.

### (3) A Drying Process

The wet membrane was dried via a four-stage oven (the temperatures of the four stages were 100° C., 100° C., 75° C. and 40° C., respectively) at a running speed of 90 m/min, finally a porous composite separator was obtained, and a thickness of the functional material layer was 25 μm.

### Example 4

### (1) A Forming Process of a Porous Separator Substrate

Organic particles (acrylonitrile-butadiene copolymer), plasticizer (paraffin oil), solvent (acetone) and filler (titanium dioxide) according to a weight ratio of 35:15:30:20 were uniformly mixed and extruded via a double screw extruder, which was first transversely and then longitudinaly stretched to form a base membrane, a transverse elongation of the stretching process was 1500%, a longitudinal elongation of the stretching process was 1000%, a thickness of the formed base membrane was 7 μm, a width of the formed base membrane was 2.5 m; then the formed base membrane was immersed into extractant (dichloroethane) to form a porous separator substrate.

### (2) A Coating Process of a Functional Material Layer

Slurry containing aluminum oxide (a particle diameter thereof was 0.3 μm) and vinylidene fluoride-hexafluoropropylene copolymer was coated on both surfaces of the formed porous separator substrate via micro-gravure coating to obtain a wet membrane.

### (3) A Drying Process

The wet membrane was dried via a three-stage oven (the temperatures of the three stages were 180° C., 180° C. and 100° C., respectively) at a running speed of 29 m/min, finally a porous composite separator was obtained, and a thickness of a single layer of the functional material layer was 3 μm (that was the thickness of the functional material layer was 6 μm).

### Example 5

### (1) A Forming Process of a Porous Separator Substrate

Organic particles (vinylidene fluoride-hexafluoropropylene copolymer), plasticizer (dioctyl phthalate) and solvent (dmethyl sulfoxide) according to a weight ratio of 50:5:45 were uniformly mixed and extruded via a double screw extruder, which was first transversely and then longitudinaly stretched to form a base membrane, a transverse elongation of the stretching process was 1200%, a longitudinal elongation of the stretching process was 900%, a thickness of the formed base membrane was 9 μm, a width of the formed base membrane was 2.5 m; then the formed base membrane was immersed into extractant (ethylene glycol) to form a porous separator substrate.

### (2) A Coating Process of a Functional Material Layer

Slurry containing acrylonitrile-styrene-butadiene copolymer was coated on one surface of the formed porous separator substrate via transfer coating to obtain a wet membrane.

### (3) A Drying Process

The wet membrane was dried via a three-stage oven (the temperatures of the three stages were 100° C., 100° C. and 40° C., respectively) at a running speed of 50 m/min, finally a porous composite separator was obtained, and a thickness of the functional material layer was 7 μm.

### Example 6

### (1) A Forming Process of a Porous Separator Substrate

Organic particles (polyethylene) were melt and extruded via a double screw extruder, which was first transversely and then longitudinaly stretched to form a porous separator substrate, a transverse elongation of the stretching process was 900%, a longitudinal elongation of the stretching process was 700%, a thickness of the formed porous separator substrate was 11 μm, a width of the formed porous separator substrate was 2.2 m.

### (2) A Coating Process of a Functional Material Layer

Slurry containing aluminum oxide (a particle diameter thereof was 0.1 μm) was coated on both surfaces of the formed porous separator substrate via dip coating to obtain a wet membrane.

### (3) A Drying Process

The wet membrane was dried via a three-stage oven (the temperatures of the three stages were 160° C., 160° C. and 75° C.) at a running speed of 38 m/min, finally a porous composite separator was obtained, and a thickness of a single layer of the functional material layer was 5 μm (that was the thickness of the functional material layer was 10 μm).

### Example 7

### (1) A Forming Process of a Porous Separator Substrate

Organic particles (vinylidene fluoride-hexafluoropropylene copolymer) were melt and extruded via a double screw extruder, which was first transversely and then longitudinaly stretched to form a porous separator substrate, a transverse elongation of the stretching process was 1400%, a longitudinal elongation of the stretching process was 1000%, a thickness of the formed porous separator substrate was 8 μm, a width of the formed porous separator substrate was 2.3 m.

### (2) A Coating Process of a Functional Material Layer

Slurry containing acrylic acid-styrene copolymer was coated on one surface of the formed porous separator substrate via micro-gravure coating to obtain a wet membrane.

### (3) A Drying Process

The wet membrane was dried via a three-stage oven (the temperatures of the three stages were 140° C., 140° C. and 80° C., respectively) at a running speed of 40 m/min, finally a porous composite separator was obtained, and a thickness of the functional material layer was 8 μm.

### Example 8

### (1) A Forming Process of a Porous Separator Substrate

Organic particles (polyimide) were made into a porous non-woven separator substrate via electrospinning, a thickness of the formed porous non-woven separator substrate was 30 μm, a width of the formed porous non-woven separator substrate was 2.6 m.

### (2) A Coating Process of a Functional Material Layer

Slurry containing aluminum oxide (a particle diameter thereof was 0.3 μm) and vinylidene fluoride-hexafluoropropylene copolymer was coated on both surfaces of the formed porous non-woven separator substrate via micro-gravure coating to obtain a wet membrane.

### (3) A Drying Process

The wet membrane was dried via a three-stage oven (the temperatures of the three stages were 180° C., 180° C. and 100° C., respectively) at a running speed of 29 m/min, finally a porous composite separator was obtained, and a thickness of a single layer of the functional material layer was 3 μm (that was the thickness of the functional material layer was 6 μm).

Finally testing processes and test results of the porous composite separators and the lithium-ion secondary batteries prepared therefrom of comparative examples 1-2 and examples 1-8 would be described.

(1) Testing of the porosity of the porous composite separators: the porosity of the porous composite separator was tested with a mercury porosimeter.

(2) Testing of the air permeability of the porous composite separators: the air permeability of the porous composite separator was tested with an air permeability tester.

(3) Testing of the puncture resistant strength of the porous composite separators: the porous composite separator was punctured with a round nail with a diameter of 0.5 mm at a speed of 50 mm/min.

(4) Testing of the heat shrinkage rate of the porous composite separators: the porous composite separator was punched into a square piece with a cutting die, then the square piece was put into a constant temperature oven at a predetermined temperature, and then the square piece was taken out after a predetermined time, the heat shrinkage rate of the square piec (the porous composite separator) before and after the heat treating process was calculated.

(5) Testing of the adhesive performance between the porous composite separators and the electrode plates: the porous composite separator was flatten, then the porous composite separator was dragged at a speed of 50 mm/min via a dynameter to test the adhesive force between the porous composite separator and the electrode plate.

Table 1 illustrated test results of the porous composite separators and the lithium-ion secondary batteries prepared therefrom of comparative examples 1-2 and examples 1-8.

TABLE 1
Test results of comparative examples 1-2 and examples 1-8

| | | | puncture | heat | adhesive |
|---|---|---|---|---|---|
| | | air | resistant | shrinkage | per- |
| | porosity | permeability | strength | rate | formance |
| | % | s/100 cc | Kgf | % | N/m |
| Comparative | 37 | 361 | 0.256 | 1.3 | 1.1 |
| example 1 | | | | | |
| Comparative | 34 | 368 | 0.259 | 1.2 | 1.7 |
| example 2 | | | | | |
| Example 1 | 39 | 353 | 0.273 | 0.2 | 2.6 |
| Example 2 | 40 | 350 | 0.267 | 0.9 | 2.4 |
| Example 3 | 39 | 359 | 0.295 | 0.1 | 2.1 |
| Example 4 | 43 | 354 | 0.275 | 0.2 | 8.4 |
| Example 5 | 41 | 354 | 0.276 | 0.6 | 9.2 |
| Example 6 | 41 | 351 | 0.274 | 0.2 | 2.9 |
| Example 7 | 42 | 354 | 0.281 | 0.4 | 8.5 |
| Example 8 | 48 | 98 | 0.280 | 0.1 | 7.9 |

It could be seen from Table 1, the porosity, the air permeability, the puncture resistant strength and the heat shrinkage rate of the porous composite separators of the present disclosure were all better than those of comparative examples 1-2, and the adhesive performance between the porous composite separator and the electrode plate of the present disclosure was also significantly increased. This was because the coating process of the functional material layer was integrated into the conventional preparation method of the porous separator substrate, therefore the coating system and the drying system which were conventionally required in the coating process of the functional material layer were omitted, thereby improving the production efficiency and lowering the production cost. The thickness and the mechanical strength of the porous composite separator were directly increased after the functional material layer was coated, thereby decreasing nonuniformity of tension on the porous separator substrate, and improving the qualified yield of the porous separator substrate, and decreasing the heat shrinkage of the porous separator substrate, and in turn improving the stability of the porous separator substrate in the heat treating process, and decreasing the strict requirements on the tension system in this process. The porous separator substrate before the heat treating process mainly was in amorphous phase, the polymer on the surface of the porous separator substrate was in open chain state, therefore performing a coating process on the functional material layer and then performing a heat treating process on the functional material layer at this time could significantly improve the interaction between the porous separator substrate and the functional material layer, and a porous composite separator with high adhesive performance, high mechanical strength and high thermal stability could be obtained by adding a heat treating process to the existing processing technology for forming the functional material layer. At the same time, the coating of the functional material layer was performed before the heat treating process, therefore the heat shrinkage of the porous composite separator during the heat treating process could be modified, which more facilitated the preparation of the porous composite separator with high air permeability.

What is claimed is:

1. A preparation method of a porous composite separator, comprising steps of:
(1) a forming process of a porous separator substrate: taking organic particles as a raw material to obtain a porous separator substrate;
(2) a coating process of a functional material layer: coating a functional material layer on at least one surface of the obtained porous separator substrate to obtain a porous separator substrate having a functional material layer;
(3) a heat treating process: drying the functional material layer and heating the porous separator substrate and the functional material layer on the surface of the porous separator substrate to obtain a porous composite separator.

2. The preparation method of the porous composite separator according to claim 1, wherein in the step (1), the forming process of the porous separator substrate comprises substeps of:
mixing organic particles, plasticizer and solvent to obtain a mixed material;
extruding the obtained mixed material and performing a processing to form a base membrane;
immersing the formed base membrane into extractant to form a porous separator substrate.

3. The preparation method of the porous composite separator according to claim 1, wherein in the step (1), the forming process of the porous separator substrate comprises substeps of:
extruding a melt of organic particles;
performing a processing on the extruded melt to form a porous separator substrate.

4. The preparation method of the porous composite separator according to claim 2, wherein the organic particle is at least one selected from a group consisting of vinyl polymer and copolymers thereof, fluoropolymer, polyimide, nitrile containing polymer, polyamide, polyester and siloxane polymer.

5. The preparation method of the porous composite separator according to claim 4, wherein when the organic particle is selected from vinyl polymer and copolymers thereof, in the heat treating process, crystallization is conducted on the porous separator substrate and a drying process is conducted on the functional material layer at the same time.

6. The preparation method of the porous composite separator according to claim 3, wherein the organic particle is at least one selected from a group consisting of vinyl polymer and copolymers thereof, fluoropolymer, polyimide, nitrile containing polymer, polyamide, polyester and siloxane polymer.

7. The preparation method of the porous composite separator according to claim 6, wherein when the organic particle is selected from vinyl polymer and copolymers thereof, in the heat treating process, crystallization is conducted on the porous separator substrate and a drying process is conducted on the functional material layer at the same time.

8. The preparation method of the porous composite separator according to claim 1, wherein a porosity of the porous composite separator is 39˜48%.

9. The preparation method of the porous composite separator according to claim 1, wherein in the step (2), the functional material layer is one selected from a group consisting of inorganic coating, organic/inorganic composite coating and organic coating.

10. The preparation method of the porous composite separator according to claim 1, wherein in the step (2), a thickness of a single layer of the functional material layer is 1 μm˜25 μm.

11. The preparation method of the porous composite separator according to claim 1, wherein in the step (3), the heat treating process comprises a substep of a high temperature treating process and a substep of a low temperature treating process which are sequentially performed, an operating temperature of the high temperature treating process is higher than an operating temperature of the low temperature treating process, and the operating temperature of the high temperature treating process is 100° C.˜300° C., the operating temperature of the low temperature treating process is 40° C.˜100° C.

12. The preparation method of the porous composite separator according to claim 11, wherein in the step (3), a multi-stage oven is used in the heat treating process, a preset temperature of the multi-stage oven is 40° C.˜300° C., a running speed of the porous separator substrate having the functional material layer is 5 m/min˜90 m/min.
